(19) United States
(12) Patent Application Publication
(10) Pub. No.: US 2015/0248943 A1
(43) Pub. Date: Sep. 3, 2015

(54) X-RAY IMAGING SYSTEM

(71) Applicant: CANON KABUSHIKI KAISHA, Tokyo (JP)

(72) Inventor: Soichiro Handa, Tokyo (JP)

(21) Appl. No.: 14/629,630

(22) Filed: Feb. 24, 2015

(30) Foreign Application Priority Data
Mar. 3, 2014 (JP) 2014-040529

(51) Int. Cl. G21K 1/06; G01N 23/04

(52) U.S. Cl. CPC G21K 1/067; G01N 23/04

(57) ABSTRACT

The present invention provides an X-ray imaging system comprising: an X-ray optical system; and an X-ray image detector configured to detect, via the X-ray optical system, an intensity distribution of an X ray emitted by an X-ray source and transmitted through an object, wherein the X-ray optical system includes a PSF modulation part configured to modulate a point spread function in such a manner that, assuming that a virtual pinhole is placed at a position of the object, an X ray transmitted through the virtual pinhole would be observed by the X-ray image detector as an image with an intensity distribution in a predetermined pattern by an action of the PSF modulation part on the X ray.

### BACKGROUND OF THE INVENTION

1. Field of the Invention

The present invention relates to an X-ray imaging system.

2. Description of the Related Art

X-ray imaging is widely used for medical image diagnosis, inspection of industrial products, and the like. In general X-ray imaging, the internal structure of an object and the like are imaged by irradiating the object with an X ray emitted by an X-ray source and detecting the intensity distribution of the transmitted X ray.

In general X-ray imaging, when the X-ray source is excessively large in size, the sharpness of an object image may be reduced by the effect of what is called geometric unsharpness. The size of the X-ray source refers to the spatial extent (represented by the diameter of the X-ray source, the length of the X-ray source on a side, or the area of the X-ray source) of an internal part (X-ray generation part) of an X-ray generation apparatus which generates effective X rays, and is referred to as a focal-spot size.

The effect of geometric unsharpness can be more appropriately suppressed by using a smaller-sized X-ray source. However, in general, a smaller-sized X-ray source needs higher mechanical accuracy and higher stability of the X-ray generation apparatus and generates a reduced amount of X rays per unit time. Hence, an attempt to reduce the size of the X-ray source leads to increased apparatus costs and an increased amount of time needed for imaging. This is disadvantageously unpractical.

### SUMMARY OF THE INVENTION

Thus, an object of the present invention is to provide an X-ray imaging system that allows a sharp object image to be obtained even when a large-sized X-ray source is used.

The present invention in its first aspect provides an X-ray imaging system comprising: an X-ray optical system; and an X-ray image detector configured to detect, via the X-ray optical system, an intensity distribution of an X ray emitted by an X-ray source and transmitted through an object, wherein the X-ray optical system includes a PSF modulation part configured to modulate a point spread function in such a manner that, assuming that a virtual pinhole is placed at a position of the object, an X ray transmitted through the virtual pinhole would be observed by the X-ray image detector as an image with an intensity distribution in a predetermined pattern by an action of the PSF modulation part on the X ray.

The present invention can provide an X-ray imaging system that allows a sharp object image to be obtained even when a large-sized X-ray source is used.

Further features of the present invention will become apparent from the following description of exemplary embodiments with reference to the attached drawings.

### BRIEF DESCRIPTION OF THE DRAWINGS

FIG. 1 is a schematic diagram depicting an X-ray imaging system according to a first embodiment;

FIG. 2A is a diagram depicting a pattern of a first grating according to Example 1, and FIG. 2B is a diagram depicting a pattern of a second grating according to Example 1;

FIG. 3 is a diagram depicting an example of a modulated point spread function according to Example 1; and

FIG. 4A is a diagram depicting a pattern of a first grating according to Example 2, and FIG. 4B is a diagram depicting a pattern of a second grating according to Example 2.

### DESCRIPTION OF THE EMBODIMENTS

Preferred embodiments of the present invention will be described below based on attached drawings. Throughout the drawings, the same members are denoted by the same reference numerals, and duplicate descriptions are omitted.

As means for obtaining a sharp object image when a large-sized X-ray source is used, a coded source imaging is known such as that described in “Antonio L. Damato et al., “Coded Source Imaging for Neutrons and X-Rays” 2006 IEEE Nuclear Science Symposium Conference Record, 199-203 (2006)”. In the coded source imaging, an X-ray source that has a more complicated shape than common X-ray sources is used to allow the point spread function of an X-ray optical system to include even relatively high spatial frequency components. A deconvolution process corresponding to the shape of the X-ray source is executed on an obtained object image, which then becomes natural.

However, the use of the coded source imaging needs an X-ray source with a special shape. Theoretically, such an X-ray source can be obtained by disposing, near the X-ray source, an X-ray shielding mask with apertures with the same shape as that in a desired X-ray source shape. However, many X-ray generation apparatuses are structured such that the X-ray source (X-ray generation part) is enclosed by a vacuum container and such that a planar X-ray generation part is disposed obliquely to the optical axis. Thus, due to this structure, keeping the X-ray shielding mask in tight contact with the X-ray source is difficult.

Thus, according to the present embodiment, the X-ray source is used without modification (in other words, the shape of the X-ray source is not controlled), and a point spread function (PSF) modulation part is provided on the side of an X-ray optical system (imaging optical system) that images an X ray having passed through the object. The PSF modulation part controls the shape of the point spread function to enable a sharp object image to be obtained in accordance with a principle similar to the principle of the coded source imaging. Moreover, the configuration according to the present embodiment allows a large-sized X-ray source to be utilized without modification. This enables avoidance of difficulty with shape control of the X-ray source, which has been a problem with the coded source imaging.

The PSF modulation part to be used is configured to modulate the point spread function in such a manner that, assuming that a virtual pinhole is placed at the position of an object, an X ray transmitted through the virtual pinhole would be observed by an X-ray image detector as an image with an intensity distribution in a predetermined pattern by the action of the PSF modulation part on the X ray. The intensity distribution in the predetermined pattern may be an intensity distribution subjected to spatial modulation at a predetermined period (that is, an X-ray image of the virtual pinhole imaged by the X-ray image detector has a density distribution at a predetermined period). In this regard, to allow the intensity distribution to be imaged using the X-ray image detector, the predetermined period of the intensity distribution is preferably longer than periods that can be resolved by the X-ray image detector (sufficiently larger than a pixel pitch of the X-ray image detector). Furthermore, the modulated point spread function preferably has shift invariance (that is, even when the position of the virtual pinhole is changed on an installation plane for the object, the pattern of the intensity distribution observed by the X-ray image detector remains unchanged). The use of the PSF modulation part meeting such a condition allows a deconvolution process to be facilitated and enables a sharp object image to be obtained.

The intensity distribution of the image detected by the X-ray image detector when the virtual pinhole is installed can be verified using computer simulation. However, in a real machine of the X-ray imaging system, verification can be performed by installing a pinhole instead of the object.

As an implementation example of the PSF modulation part, a configuration will be described below which modulates the point spread function of the X-ray optical system utilizing a plurality of gratings with a fine periodic structure and a Talbot effect associated with an X ray.

The Talbot effect is an effect in which, when a wave such as an electromagnetic wave is diffracted by gratings with a periodic structure, images with a period similar to that of the gratings (interference pattern) are generated at regular propagation distances. The Talbot effect associated with an X ray is known to be usable for what is called phase imaging and is described in, for example, WO 2004/058070 in detail.

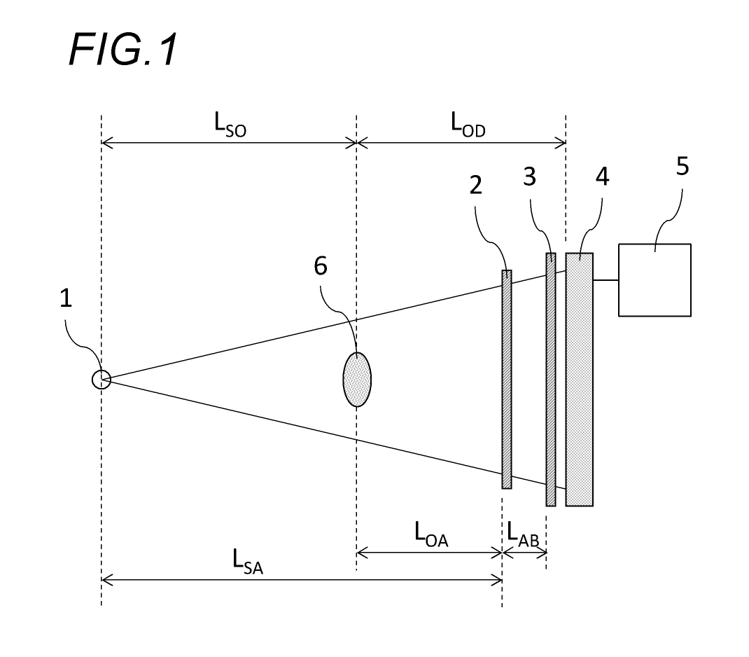

In the present embodiment, to modulate the point spread function of the imaging optical system based on two gratings and the Talbot effect, the X-ray imaging system is configured as depicted in FIG. 1. In FIG. 1, the X-ray imaging system has an X-ray source 1, a first grating 2, a second grating 3, an X-ray image detector 4, and a processing unit 5. The first grating 2 and the second grating 3 are both disposed between an object 6 and the X-ray image detector 4. An X ray emitted by the X-ray source 1 is transmitted through the object 6, passes through the first grating 2 and the second grating 3, and enters the X-ray image detector 4. The X-ray image detector 4 detects the intensity distribution (that is, the object image) of the incident X ray. The X-ray image detector 4 then transmits information on the detected object image to the processing unit 5.

The first grating 2 and the second grating 3 are disposed with the Talbot effect of the first grating 2 on an X ray taken into account. Specifically, an X ray is assumed to be generated by the X-ray source 1 and to pass through any very small area on an installation plane for the object 6 to form a spherical wave. The X ray passes through the first grating 2 to exert a Talbot effect, causing the appearance of a high-contrast interference pattern. The second grating 3 is disposed where the interference pattern is to appear. A moire phenomenon occurring between the interference pattern and the second grating 3 spatially modulates an image of the X-ray source projected on the X-ray image detector 4. This allows the point spread function of the imaging optical system to be modulated.

Gratings with a one- or two-dimensional periodic pattern may be used as the first grating 2 and the second grating 3. Gratings with a two-dimensional periodic pattern are preferably used because such gratings allow the sharpness of an image obtained to be two-dimensionally improved. Either a phase grating or an absorption grating may be used as the first grating 2. However, the phase grating is preferably used in order to reduce a loss in X ray. The absorption grating may be used as the second grating 3.

The processing unit 5 is a computer with a processor, a memory, a storage device, an I/O device, and the like. The processing unit 5 has a function to process and analyze image information obtained from the X-ray image detector 4 and to control the parts of the X-ray imaging system. These processes may be implemented by the processor by executing programs stored in memory or the storage apparatus. Alternatively, some of the functions may be executed by hardware such as logic circuits. The processing unit 5 may be configured using a general-purpose computer or dedicated hardware such as a board computer or an ASIC.

The processing unit 5 performs deconvolution on an acquired object image to calculate a visually natural object image. The processing unit 5 may pre-acquire information on the point spread function of the optical system modulated by the effects of the first grating 2 and the second grating 3 so as to perform deconvolution that depends on the point spread function.

The following will be described below: conditions to be met by the periods and arrangements of the first grating 2 and the second grating 3 and modulation of the point spread function of the imaging optical system resulting from the effects of the gratings.

In general, a Talbot length L_{T} (the period at which the same wave field appears by the Talbot effect) with respect to an incident wave of a planar wave is expressed by:

L_{T}=2d²/λ (1).

In this equation, the period of the grating is denoted by d, and the wavelength of a wave is denoted by λ. Thus, a coefficient p can be used to write a distance L_{T}′ at which a grating with the period d providing a particular modulation pattern to the amplitude or phase of the incident planar wave causes the appearance of a particular interference pattern with respect to the incident planar wave with a wavelength λ, as follows.

L_{T}′=pd²/λ (2)

The coefficient p may be considered to be a generalized Talbot order.

Thus, a distance L_{ABO} at which the first grating 2 causes the appearance of a particular high-contrast interference pattern with respect to an incident X-ray planar wave with a wavelength λ_{E} may be written by:

L_{ABO}=pd_{A}²/λ_{E} (3)

In this equation, reference character d_{A} in principle denotes the period of the first grating 2 but is defined herein as the period of the high-contrast interference pattern with respect to the incident X-ray planar wave. Thus, reference character d_{A} may be the period of the first grating or may be the period of the first grating divided by an integer.

To determine the position where an X ray having passed through any very small area on the installation plane for the object to form a spherical-wave-shaped wave exerts a Talbot effect to cause the appearance of the high-contrast interference pattern upon passing through the first grating 2, Formula (3) based on the assumption that the incident X ray is a planar wave needs to be corrected. Specifically, to allow the second grating 3 to be placed where the spherical wave passes through the first grating 2 to exert a Talbot effect to cause the appearance of the high-contrast interference pattern, the distance L_{AB} between the first grating 2 and the second grating 3 may be defined by:

L_{AB}=L_{OA}L_{ABO}/(L_{OA}−L_{ABO}) (4).

In this equation, the distance between the installation plane for the object 6 and the first grating 2 is denoted by L_{OA}.

Moreover, the period d_{B} of the second grating 3 according to the present embodiment has a value expressed by:

d_{B}=d_{A}(L_{SA}+L_{AB})/L_{SA} (5).

In this equation, the distance between the X-ray source 1 and the first grating 2 is denoted by L_{SA}. Thus, a state (shift invariance) can be achieved where the point spread function has approximately similar shapes in any area on the installation plane for the object. This facilitates a subsequent deconvolution process.

In this regard, a modulation period d_{M} for the point spread function on the X-ray image detector 4 is expressed by:

d_{M}=d_{B}L_{SA}L_{OD}/(L_{AB}L_{SO}) (6).

In this equation, the distance between the installation plane for the object 6 and the X-ray image detector 4 is denoted by L_{OD}, and the distance between the X-ray source 1 and the installation plane for the object 6 is denoted by L_{SO}. Furthermore, when the size of the X-ray source is denoted by D, the overall size (that is, the size of the area where the function having values significantly far from zero) D′ of the point spread function on the X-ray image detector 4 can be written by:

D′=DL_{OD}/L_{SO} (7).

Thus, to make the modulation period for the point spread function smaller than the overall size of the function (d_{M}<D′), Formula (8) may be given.

d_{B}L_{SA}/L_{AB}<D (8)

The size D of the X-ray source can be defined by, for example, a half-value width or the size of the area which an X ray with a predetermined intensity is emitted (the diameter or the length on a side).

Moreover, to make the modulation of the point spread function significantly effective, the modulation period d_{M} needs to be longer than the minimum spatial period that can be resolved by the X-ray image detector 4. Thus, when the resolvable minimum period is denoted by d_{R}, Formula (9) may be given.

d_{B}L_{SA}L_{OD}/(L_{AB}L_{SO})>d_{R} (9)

The resolvable minimum period d_{R} can be set equal to, for example, double the pixel pitch of the X-ray image detector 4.

As described above, the effect of the modulation of the point spread function performed by the first grating 2 and the second grating 3 can be verified by checking the intensity distribution of an X-ray image observed by the X-ray image detector 4 when a pinhole is installed instead of the object 6. Furthermore, shift invariance can be verified by checking a possible change in the intensity distribution of the X-ray image when the position of the pinhole is changed within the installation plane for the object 6.

In the X-ray imaging system according to the present embodiment, in a case where the object 6 is not present, X ray from the X-ray source 1 does not have a significant degree of spatial coherence at the position of the first grating 2. Hence, no significant high-contrast interference pattern is formed at the position of the second grating 3, thus preventing the second grating 3 from forming a moire image. In this case, an X-ray image with a uniform intensity is observed by the X-ray image detector 4.

A Talbot interferometer and a Talbot-Lau interferometer utilize the Talbot effect and moire phenomenon based on two gratings and are thus seemingly similar to the system according to the present embodiment. However, these interferometers differ from the system according to the present embodiment in that a moire phenomenon is observed even when no object is present. In addition, for the interferometers, the distance between the two gratings is designed such that a spherical wave centered around a point on an X-ray source or a source grating in the Talbot-Lau interferometer forms a high-contrast interference pattern at the position of the downstream grating by the Talbot effect. Thus, the interferometers are different from the system according to the present embodiment in which the distance between the two gratings is designed such that a spherical wave centered around a point on the installation plane for the object forms a high-contrast interference pattern at the position of the downstream grating, as represented by Formula (4). The coded source imaging is different from the system according to the present embodiment in that the point spread function is modulated by action on an X ray that has not entered the object yet. In other words, the coded source imaging is different from the system according to the present embodiment in that PSF modulation part is disposed upstream of the object. Thus, each of the above-described conventional systems and the system according to the present embodiment can be easily distinguished from each other by checking an X-ray image obtained when no object is present and whether or not the PSF modulation part acts on an X ray transmitted through the object.

More specific examples of the present embodiment will be described below.

### Example 1

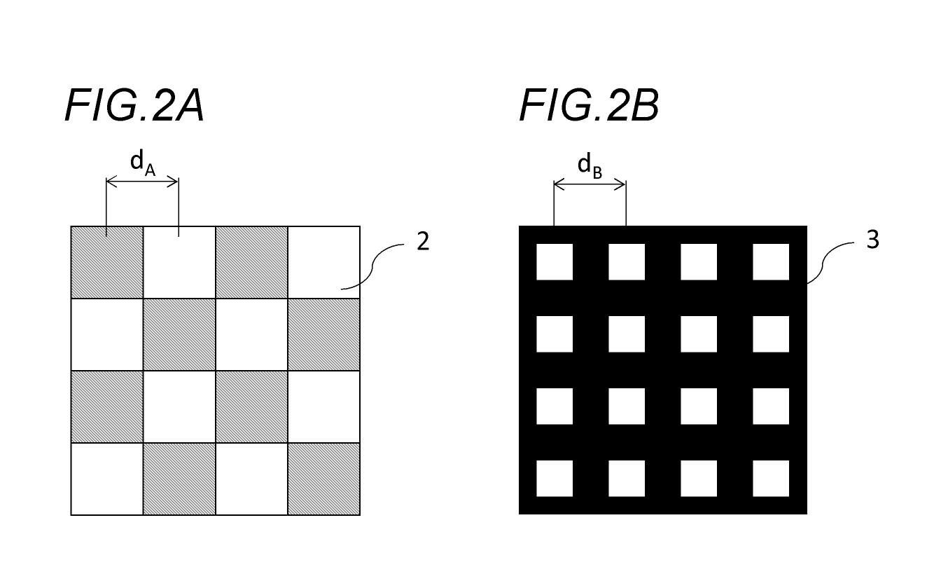

The X-ray source 1 is an X-ray generation part on an anode in an X-ray tube. An anode material is molybdenum, which allows characteristic X rays with a photon energy of 17.5 keV to be generated. Furthermore, the X-ray source 1 has an effective shape similar to a square of 240 μm on a side. Thus, in the present example, D=240 μm. The first grating 2 has such a pattern as depicted in FIG. 2A. The first grating 2 is formed of silicon and can provide phase modulation of π rad to an incident X ray of 17.5 keV by the difference in the thickness of the silicon. Shaded portions and non-shaded portions of FIG. 2A represent phase lead portions and phase lag portions, respectively. In the present example, d_{A} corresponds to a length depicted in FIG. 2A, and d_{A}=2.199 μm. Additionally, the second grating 3 has such a pattern as depicted in FIG. 2B. The second grating 3 is formed of gold, and has apertures periodically arranged therein and through which an X ray is transmitted. Colored portions and uncolored portions of FIG. 2B represent the gold, which corresponds to X-ray shielding portions, and the apertures, which correspond to X-ray transmission portions, respectively. d_{B} corresponds to a length depicted in FIG. 2B, and d_{B}=2.240 μm. In addition, the X-ray image detector 4 is a flat panel detector, the pixel size is 30 μm, and the resolvable minimum period d_{R} is approximately 60 μm.

The distance L_{OA} between the installation plane for the object 6 and the first grating 2 is 0.9 m. Furthermore, in general, a π modulation grating with such a pattern as depicted in FIG. 2A causes the appearance of a high-contrast interference pattern shaped like a square grating and having a period d_{A}, at a position corresponding to the distance L_{ABO}=0.5 d_{A}²/λE, with respect to an incident X-ray planar wave with a wavelength λ_{E}. Thus, when λ_{E} is the wavelength corresponding to an X ray of 17.5 keV, the distance L_{AB} between the two gratings can be calculated to be L_{AB}=35.5 mm using the present equation and Formula (4). Therefore, in the present example, the first grating 2 and the second grating 3 are arranged such that the distance L_{AB} between the first grating 2 and the second grating 3 is 35.5 mm.

Furthermore, the distance L_{SA} between the X-ray source 1 and the first grating 2 is 1.9 m. In this case, the optical system meets Formula (5) to allow a state to be achieved where the point spread function has approximately similar shapes in any area on the installation plane for the object.

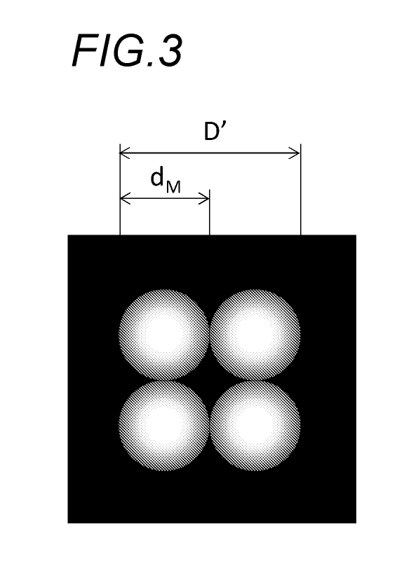

Additionally, the distance L_{SO} between the X-ray source 1 and the installation plane for the object 6 is 1 m. The distance L_{OD} between the installation plane for the object 6 and the X-ray image detector 4 is 1 m. Thus, the use of Formula (6) allows the modulation period d_{M} of the point spread function on the X-ray image detector 4 to be calculated to be d_{M}=120 μm. Furthermore, the use of Formula (7) allows the overall size D′ of the point spread function on the X-ray image detector 4 to be calculated to be D′=240 μm. As described above, the optical system meets Formula (8), and the modulation period of the point spread function is smaller than the overall size of the function. FIG. 3 schematically depicts an image observed by the X-ray image detector 4 when a pinhole is placed on the installation plane for the object 6, that is, a substantial point spread function.

The minimum period d_{R} resolvable by the X-ray image detector 4 is approximately 60 μm, and the optical system meets Formula (9). Thus, the modulation of the point spread function is significantly effective.

### Example 2

In Example 2, the point spread function is one-dimensionally modulated unlike in Example 1. This enables an increase in the spatial resolution for one particular direction.

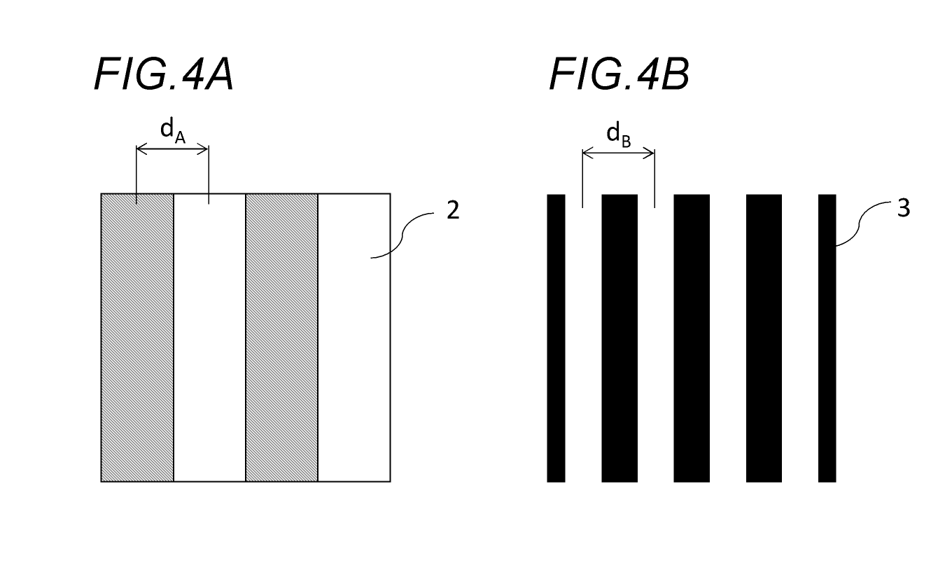

The first grating 2 has such a pattern as depicted in FIG. 4A. The first grating 2 is formed of silicon as in Example 1, and can provide phase modulation of π rad to an incident X ray of 17.5 keV by the difference in the thickness of the silicon. Shaded portions and non-shaded portions of FIG. 4A represent phase lead portions and phase lag portions, respectively. In the present example, d_{A} corresponds to a length depicted in FIG. 4A, and d_{A}=2.199 μm. Additionally, the second grating 3 has such a pattern as depicted in FIG. 4B. The second grating 3 is formed of gold, and has apertures (slits) periodically arranged therein and through which an X ray is transmitted. Colored portions and uncolored portions of FIG. 4B represent the gold, which corresponds to X-ray shielding portions, and the apertures (slits), which correspond to X-ray transmission portions, respectively. d_{B} corresponds to a length depicted in FIG. 4B, and d_{B}=2.240 μm. In addition, the X-ray source 1 and the X-ray image detector 4 are similar to the X-ray source 1 and X-ray image detector 4 in Example 1.

The distance L_{OA} between the installation plane for the object 6 and the first grating 2 is 0.9 m. Furthermore, in general, a π modulation grating with such a pattern as depicted in FIG. 4A causes the appearance of a one-dimensional high-contrast interference pattern having a period d_{A}, at a position corresponding to the distance L_{ABO}=0.5 d_{A}²/λ_{E}, with respect to an incident X-ray planar wave with a wavelength λ_{E}. Thus, λ_{E} is when the wavelength corresponding to an X ray of 17.5 keV, the distance L_{AB} between the two gratings can be calculated to be L_{AB}=35.5 mm using the present equation and Formula (4). Therefore, in the present example, the first grating 2 and the second grating 3 are arranged such that the distance L_{AB} between the first grating 2 and the second grating 3 is 35.5 mm.

In addition, the components providing the optical system are arranged as is the case with Example 1. Thus, the use of one-dimensional gratings allows the point spread function to be one-dimensionally modulated.

The preferred embodiments of the present invention have been described. However, the present invention is not limited to the embodiments, and many variations and changes may be made to the embodiments without departing from the spirits of the present invention. For example, the above-described embodiments use the two gratings, the first grating and the second grating. However, these gratings may be combined with other gratings with different functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-040529, filed on Mar. 3, 2014, which is hereby incorporated by reference herein in its entirety.

What is claimed is:

1. An X-ray imaging system comprising:
an X-ray optical system; and
an X-ray image detector configured to detect, via the X-ray optical system, an intensity distribution of an X ray emitted by an X-ray source and transmitted through an object,
wherein the X-ray optical system includes a PSF modulation part configured to modulate a point spread function in such a manner that, assuming that a virtual pinhole is placed at a position of the object, an X ray transmitted through the virtual pinhole would be observed by the X-ray image detector as an image with an intensity distribution in a predetermined pattern by an action of the PSF modulation part on the X ray.

2. The X-ray imaging system according to claim 1, wherein, in a case where the object is not present, an X-ray image with a uniform intensity is observed by the X-ray image detector, and
in a case where a pinhole is placed instead of the object, an X-ray image with the intensity distribution in the predetermined pattern is observed by the X-ray image detector.

3. The X-ray imaging system according to claim 1, wherein the intensity distribution in the predetermined pattern is an intensity distribution spatially modulated at a predetermined period.

4. The X-ray imaging system according to claim 3, wherein the predetermined period of the spatially modulated intensity distribution is longer than a period that is resolvable by the X-ray image detector.

5. The X-ray imaging system according to claim 1, wherein the PSF modulation part is formed of a plurality of gratings disposed between the object and the X-ray image detector, and
the image with the intensity distribution in the predetermined pattern is a moire image formed by the plurality of gratings.

6. The X-ray imaging system according to claim 5, wherein the plurality of gratings include a first grating configured to form an interference pattern of the X ray transmitted through the virtual pinhole by a Talbot effect, and a second grating configured to form a moire image between the interference pattern and the second grating.

7. The X-ray imaging system according to claim 6, wherein,
d_{B}=d_{A}(L_{SA}+L_{AB})/L_{SA} is satisfied,
where d_{A} denotes a period of the first grating, L_{SA} denotes a distance from the X-ray source to the first grating, d_{B} denotes a period of the second grating, and L_{AB} denotes a distance from the first grating to the second grating.

8. The X-ray imaging system according to claim 6, wherein,
d_{B}L_{SA}/L_{AB}<D, and
d_{B}L_{SA}L_{OD}/(L_{AB}L_{SO})>d_{R} are satisfied,
where d_{A} denotes a period of the first grating, L_{SA} denotes a distance from the X-ray source to the first grating, d_{B} denotes a period of the second grating, L_{AB} denotes a distance from the first grating to the second grating, D denotes a size of the X-ray source, L_{SO} denotes a distance from the X-ray source to the object, L_{OD} denotes a distance from the object to the X-ray image detector, and d_{R} denotes a minimum spatial period that is resolvable by the X-ray image detector.

9. The X-ray imaging system according to claim 6, wherein the first grating and the second grating each have a two-dimensional periodic pattern.

10. The X-ray imaging system according to claim 6, wherein the first grating is a phase grating.
